(19) United States
(12) Patent Application Publication
(10) Pub. No.: US 2011/0012312 A1
(43) Pub. Date: Jan. 20, 2011

(54) PRESSURE REGULATING SEAL

(75) Inventor: Daniel K. Zitting, St. George, UT (US)

Correspondence Address: TRASKBRITT, P.C., P.O. BOX 2550, SALT LAKE CITY, UT, 84110, US

(73) Assignee: SKF POLYSEAL INC., Salt Lake City, UT (US)

(21) Appl. No.: 12/921,725

(22) PCT Filed: Mar. 10, 2009
(86) PCT No.: PCT/US09/36665

§ 371 Date: Sep. 9, 2010

Related U.S. Application Data
(60) Provisional application No. 61/035,305, filed on Mar. 10, 2008.

(51) Int. Cl. F16J 15/16

(52) U.S. Cl. 277/500

(57) ABSTRACT

Seals and apparatuses incorporating seals are provided. In one embodiment an apparatus is provided including two relatively machine elements, the first machine (204) element having a gland (202) formed therein. The gland has a first axial wall, a second axial wall and a radial wall disposed therebetween. The apparatus further includes a sealing ring (208) disposed at least partially within the gland, the sealing ring having a radially inner face (212) in contact with the first machine elements, a radially outer face (217), a first axial face (216), a second axial face (214) spaced apart from the first axial face, an angled face (218) extending between the first axial face and the radially outer face, and at least one channel (220) formed in the angled face and extending from the first axial face to the radially outer face. A loading ring (210) is configured to maintain contact with the angled face of the sealing ring, the first axial wall of the gland and the radial wall of the gland.

### PRIORITY CLAIM

This application claims the benefit of the filing date of U.S. Provisional Patent Application Ser. No. 61/035,305, filed Mar. 10, 2008, for “Pressure Regulating Seal.”

### TECHNICAL FIELD

The present invention relates generally to providing a fluid seal between two relatively movable machine parts such as a piston or a rod moving within a bore and, more specifically, embodiments of the present invention relate to a pressure regulating seal that can prevent or minimize potential inverted pressure and over pressure situations.

### BACKGROUND

Seals adapted to provide a fluid seal between two relatively moving machine elements are well known in the art. For example, one or more sealing elements are commonly used to provide a fluid seal between a piston or rod moving within, and relative to, a bore extending through a housing or other machine element. Although a single seal may be disposed between an outer cylindrical surface of the piston or rod and an inner cylindrical surface of the bore, it is a common practice to employ a combination of two or more sealing elements to provide a robust fluid seal between the two relatively moving machine elements. Additionally, multiple seals or seal assemblies may be incorporated into a given device.

For example, many sealing arrangements include a primary seal, intended to provide a fluid seal between two relatively movable machine parts (e.g., a piston or rod within a bore). These seals are sometimes referred to as rod seals. The primary seal (or rod seal) is conventionally disposed between a system or high pressure fluid side and an external or low pressure fluid side. In addition to the primary seal, a buffer seal may be disposed between the two machine parts and on the high pressure side of the primary seal to protect the primary seal, or rod seal, from pressure fluctuations and system contaminants. Further, in some arrangements, another seal may be disposed on the low pressure side of the primary seal to protect the primary seal from environmental contaminants. Such seals are sometimes referred to as wiper seals.

An example of sealing arrangements is described in U.S. Pat. No. 6,595,524 to Zitting, entitled PRESSURE REGULATING BUFFER SEAL.

Referring now to FIG. 1, a cross-sectional view of a buffer seal 100 is shown installed in a gland 102 or annular groove of a bore 104 and configured to seal the bore and a piston or rod 106. The buffer seal 100 is configured as what is known as a “stepped” buffer seal and includes a sealing ring 108 configured to contact the rod 106. Additionally, the buffer seal 100 includes a loading or biasing element 110 configured to help maintain the sealing ring 108 in contact with the rod 106. The buffer seal 100 is positioned between a high pressure side H and a low pressure side L.

Often, when installed, the sealing ring 108, the biasing element 110, or both, will become twisted, displaced or deformed (or some combination thereof), such that small pockets or volumes 112 are formed on the low pressure side L of the buffer seal 100 as is shown in FIG. 2. During operation of the system or device in which the buffer seal 100 is disposed or installed, a fluid pressure may press on the sealing ring 108 from high pressure side H (i.e., during a pressure spike or fluctuation) such that sealing ring 108 is displaced and the volumes 112 are collapsed and disappear as shown in FIG. 3. Due to the displacement of the sealing ring 108 and/or biasing ring 110, and the fact that fluids being sealed by the buffer seal 100 often act as substantially incompressible fluids, the pressure of the fluid on the low pressure side L of the buffer seal 100 increases dramatically, often such that it exceeds the pressure of the fluid on the high pressure side H. Such an inverted pressure condition may be harmful to the buffer seal 100, to a primary seal (not shown) that may be disposed on the low pressure side L of the buffer seal 100, or to other system components.

Various types of seals have been proposed to provide some type of pressure control in situations such as inverted pressure events. One such type of pressure regulating seal is described in the above referenced U.S. Pat. No. 6,595,524.

However, it is desired within the sealing industry to continually improve the performance of such buffer seals and provide economical and efficient sealing solutions.

### DISCLOSURE OF THE INVENTION

Embodiments of the present invention include seals and apparatuses incorporating seals. In accordance with one embodiment of the present invention, a seal is provided. The seal includes a sealing ring having a radially inner face, a radially outer face, a first axial face, a second axial face spaced apart from the first axial face, an angled face extending between the first axial face and the radially outer face, and at least one channel formed in the angled face and extending from the first axial face to the radially outer face. A loading ring is contiguous with the angled face of the sealing ring and configured to impart both a radial force and an axial force to the sealing ring. In one embodiment, the angled face may exhibit an angle of between approximately 10° and approximately 50° relative to the radially inner face.

In accordance with another embodiment an apparatus is provided including a first machine element and a second machine element having a gland formed therein. The gland has a first axial wall, a second axial wall and a radial wall disposed between the first axial wall and the second axial wall. The first machine element and the second machine element are relatively movable with respect to each other. The apparatus further includes a sealing ring disposed at least partially within the gland, the sealing ring having a radially inner face in contact with the first machine element, a radially outer face, a first axial face, a second axial face spaced apart from the first axial face, an angled face extending between the first axial face and the radially outer face, and at least one channel formed in the angled face and extending from the first axial face to the radially outer face. A loading ring is configured to maintain contact with the angled face of the sealing ring, the first axial wall of the gland and the radial wall of the gland.

### BRIEF DESCRIPTION OF THE DRAWINGS

The foregoing and other advantages of the invention will become apparent upon reading the following detailed description and upon reference to the drawings in which:

FIG. 1 is a cross-sectional or profile view of a buffer seal;

FIG. 2 is a cross-sectional or profile view of the buffer seal of FIG. 1 in one condition or state during operation or use;

FIG. 3 is a cross-sectional or profile view of the buffer seal of FIG. 1 in a second condition or state during operation or use;

FIG. 4 is a partial cross-sectional, perspective view of a buffer seal in accordance to an embodiment of the present invention;

FIG. 5 is a cross-sectional view of the buffer seal of FIG. 4, installed between two relatively movable machine components while in a first condition or state;

FIG. 6 is a cross-sectional view of the buffer seal of FIG. 4, installed between two relatively movable machine components while in a second condition or state; and

FIG. 7 is a graph showing the performance of the buffer seal of FIG. 4 under pressure spike conditions.

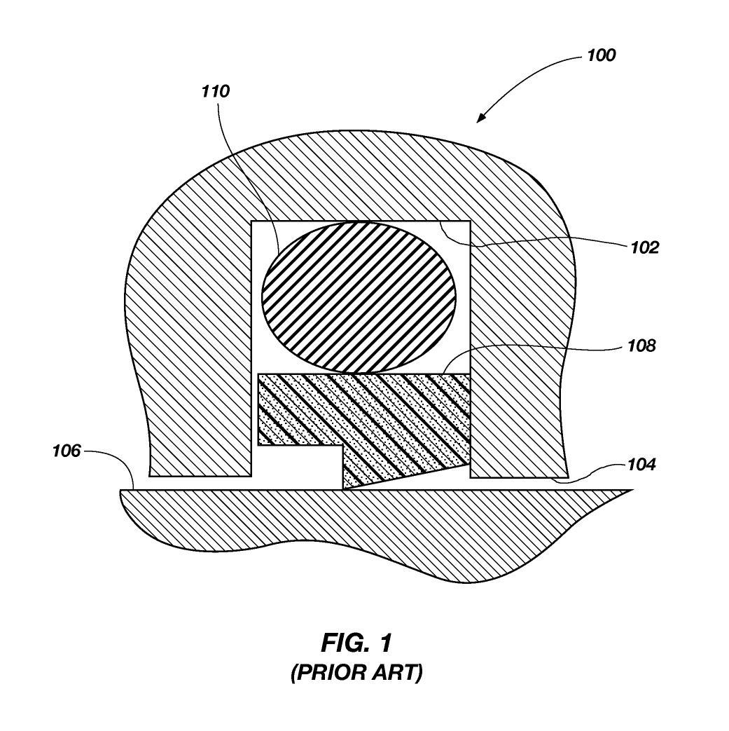

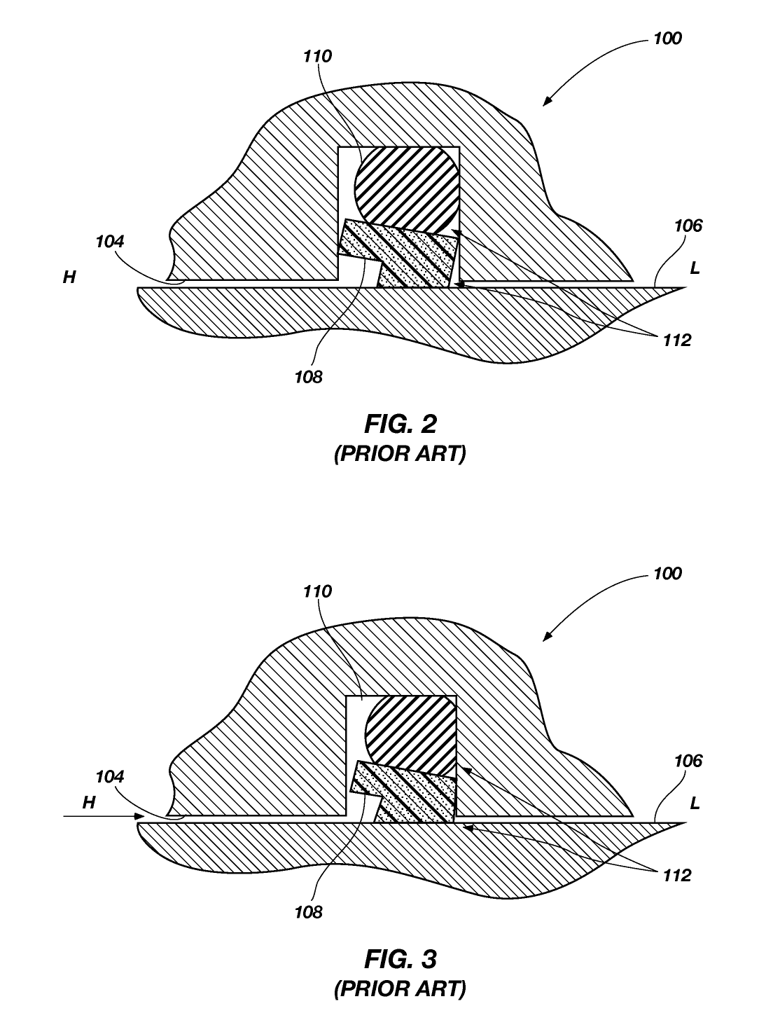

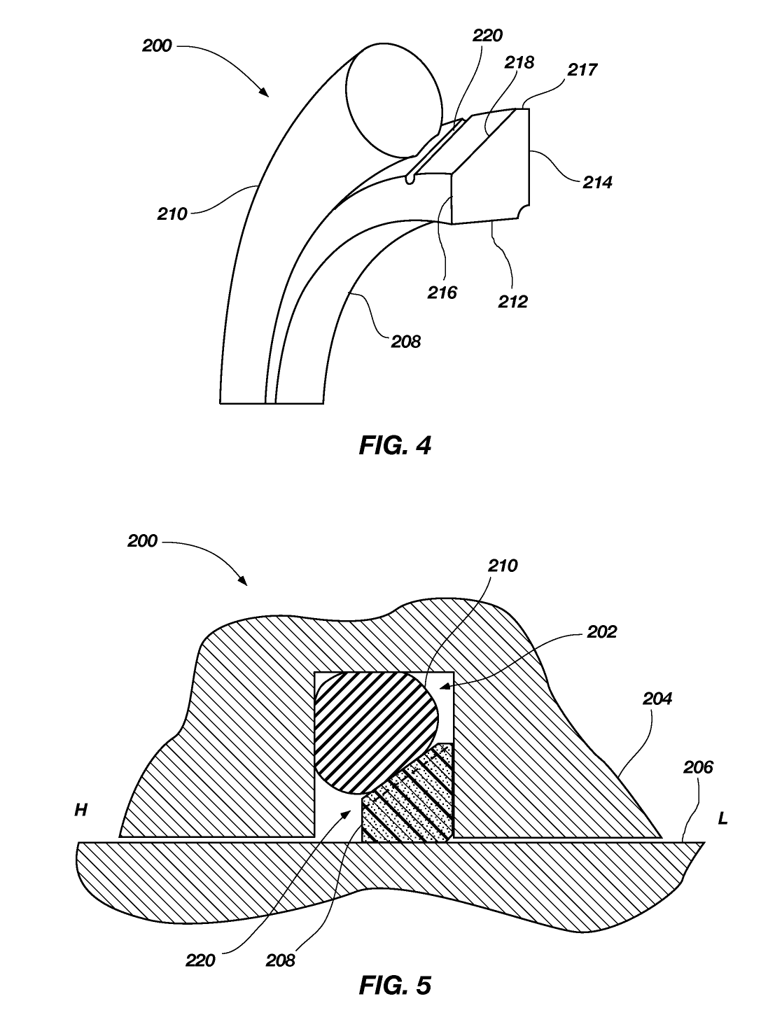

### MODE(S) FOR CARRYING OUT THE INVENTION

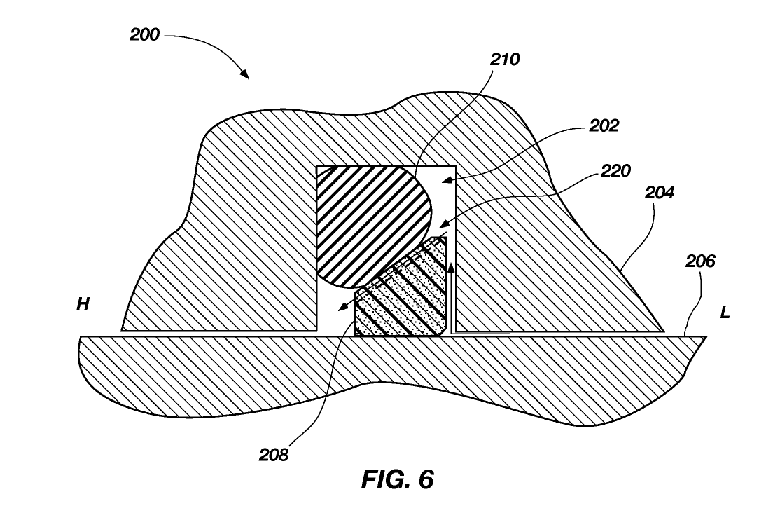

Referring to FIGS. 4 and 5, a pressure regulating buffer seal 200 is shown and described. As shown in FIG. 5, the buffer seal 200 may be disposed in a gland 202 of a bore or cylinder 204 and configured to form a seal between the cylinder 204 and a piston or rod 206 disposed within the cylinder 204. The buffer seal 200 is disposed between what may be termed a high pressure side H and a low pressure side L of a system. As will be appreciated by those of ordinary skill in the art, and consistent with the above referenced U.S. Pat. No. 6,595,524, one or more additional seals (not shown) may be located between the cylinder 204 and rod 206, such as on the low pressure side L. It is noted, that, while such are designated as high and low pressure sides (H and L), there may be little (or no) difference in pressure during certain intended operating conditions. Thus, such designations are not to be taken as limiting or as being absolute (particularly as inverted pressure conditions may arise under certain operating conditions as discussed further below).

As will also be appreciated by those of ordinary skill in the art, the buffer seal 200 may also be utilized with other arrangements of relatively movable components. For example, in another configuration, the gland 202 or groove may be formed in the rod 206 instead of in the cylinder 204.

The buffer seal 200 includes a sealing ring 208 and a biasing member or a loading ring 210. In one embodiment, the sealing ring 208 may be formed of a material that includes polytetrafluoroethylene (PTFE) and, optionally, a filler material. The sealing ring 208 may be formed to include radially inner face (also referred to as a sealing face 212 for convenience) that engages the rod 206; an axial face 214 that is configured to engage a corresponding axial wall of the gland 202 depending on a pressure state of the system; a face 216 that is axially spaced from the axial face 214 (and which shall be referred to herein as a pressure side face 216 or a second axial face for purposes of convenience and clarity); a radially outer face 217; and an angled face 218 extending between the pressure side face 216 and the radially outer face 217. It is noted that, as shown in the embodiment shown in FIGS. 4 and 5, the pressure side face 216 may be substantially parallel to the axial face 214 and the radially outer face 217 may be substantially parallel and concentric with the sealing face 212. However, in other embodiments, these faces may exhibit different relationships to one another.

The angled face 218 may form a structure that, in complete profile, provides the sealing ring 208 with substantially frustoconical geometry. The angled face 218 may be formed at one of a variety of angles relative to the sealing face 212. For example, in one embodiment, the angled face 218 may be at an angle of approximately 10° to approximately 50° relative to the sealing face 212. In other embodiments, the angle between the angled face 218 and the sealing face 212 may be different.

It is noted that other embodiments may include a sealing ring 208 that is configured without a radially outer face 217 such that the angled face 216 extends directly between the pressure side face 216 and the axial face 214. In such an embodiment, the channels 220 may likewise extend from the pressure side face 216 and the axial face 214.

One or more grooves or channels 220 may be formed in the angled face 218. As will be described in further detail hereinbelow, the channels 220 may provide a conduit for fluid to flow through under certain pressure conditions during the operation of the seal 200. The channels extend from the axial face 217 to the pressure face 216. In one embodiment, a plurality of channels 220 are formed in the angled face 218 in a desired pattern, circumferentially spaced about the sealing ring 208.

The loading ring 210 may include a substantially resilient element that is configured to provide a biasing force on the sealing ring 208. In one embodiment, the loading ring may comprise an O-ring formed, for example, from a natural or synthetic elastomer. When the buffer seal 200 is installed within the gland 202, the loading ring 210 maintains contact with the radially outer wall of the gland 202 and the high pressure side H axial wall of the gland 202. Additionally, the loading ring 210 maintains contact with the angled face 218 of the sealing ring 208. Such an arrangement maintains both an axial biasing force and radial biasing force on the sealing ring 208. It is additionally noted that, while the loading ring 210 maintains contact with the angled face 218 of the sealing ring 208, the loading ring 210 does not block or occlude the channels 220 or otherwise disrupt potential fluid flow through the channels 220.

During operation, the buffer seal 200 may be subject to pressure fluctuations or pressure spikes from the high pressure side H. As previously discussed, prior art seals often transmit, and even amplify, these pressure spikes from the high pressure side H to the low pressure side L of the seal. The present invention helps to prevent transmission of such high pressure spikes and, further, in the case of an inverted pressure situation (i.e., when the low pressure side L actually exhibits a higher pressure than the high pressure side H), provides pressure relief or equalization.

The configuration of the sealing ring 208 provides a seal face 212 with substantial contact surface area (i.e., the surface area in contact with the rod 206) as well as an axial face 214 having substantial contact surface area (i.e., the surface area in contact with the low pressure side L axial wall of the gland 202). This arrangement helps to eliminate, or at least reduce, the amount of shifting (i.e., displacement and deformation) exhibited by the sealing ring upon application of a pressure from the high pressure side H during normal operation of the seal. Thus, when a pressure spike occurs, there are no (or minimal) volumes or pockets formed on the low pressure side L that will collapse as described with respect to prior art seals. This helps to reduce or eliminate many inverted pressure situations.

Moreover, in the event that an inverted pressure situation does occur, the pressure inversion will cause the sealing ring 208 to become displaced towards the normally high pressure side H, as indicated in FIG. 6, such that fluid may flow may flow from the normally low pressure side L, between the axial face 214 of the sealing ring 208 and the corresponding axial wall of the gland 202, and through the channels 220 (as indicated by the flow arrow lines in FIG. 6) to the normally high pressure side H of the seal until the pressure on the normally low pressure side L of the seal had dropped to a level sufficient such that the sealing ring 208 is displaced (such as by forces of fluid pressure on the high pressure side H of the seal 200 and/or the forces applied to the sealing ring 208 by the loading ring 210) and the axial face 214 is again in contact with the corresponding axial wall of the gland 202.

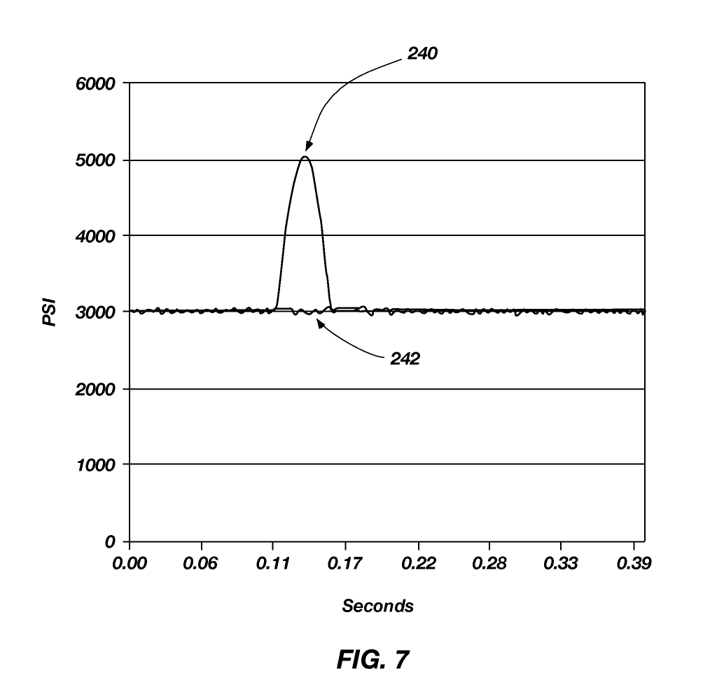

Referring briefly to FIG. 7, a test was conducted to determine the ability of the buffer seal 200 to withstand pressure spikes or fluctuations without transferring such pressure spikes or fluctuations to the low pressure side L thereof. As seen in FIG. 7, the buffer seal 200 was subjected to an operating pressure of approximately 20.68 MPa (3,000 pounds per square inch (psi)), the pressure being substantially equal on both sides of the seal 200. A pressure spike was introduced on the high pressure side H of the seal 200, the pressure spike reaching a peak pressure of greater than 34.47 MPa (5,000 psi) as indicated at 240. However, the low pressure side L of the seal 200 remained at approximately 20.68 MPa (3,000 psi), as indicated at 242, and was virtually unaffected by the pressure fluctuation experienced by the high pressure side H of the seal 200.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims and their legal equivalents.

1. A seal configured to be disposed in a gland, the seal comprising:
a sealing ring having a radially inner face, a radially outer face, a first axial face, a second axial face spaced apart from the first axial face, an angled face extending between the first axial face and the radially outer face, and at least one channel formed in the angled face and extending from the first axial face to the radially outer face; and
a loading ring contiguous with the angled face of the sealing ring and configured to impart both a radial force and an axial force to the sealing ring.

2. The seal of claim 1, wherein the angled face is oriented at an angle of between approximately 10° and approximately 50° relative to the radially inner face.

3. The seal of claim 1, wherein the at least one channel includes a plurality of circumferentially spaced channels.

4. The seal of claim 1, wherein the sealing ring is formed of a material comprising polytetrafluoroethylene.

5. The seal of claim 4, wherein the loading ring is an O-ring.

6. The seal of claim 5, wherein the O-ring comprises a natural or a synthetic elastomer.

7. The seal of claim 1, wherein the first axial face and the second axial face are substantially parallel to one another.

8. The seal of claim 7, wherein the radially inner face and the radially outer face are substantially parallel to, and substantially concentric with, one another.

9. An apparatus comprising:
a first machine element;
a second machine element having a gland formed therein, the gland having a first axial wall, a second axial wall and a radial wall disposed between the first axial wall and the second axial wall, the first machine element and the second machine element being relatively movable with respect to each other;
a sealing ring disposed at least partially within the gland, the sealing ring having a radially inner face in contact with the first machine element, a radially outer face, a first axial face, a second axial face spaced apart from the first axial face, an angled face extending between the first axial face and the radially outer face, and at least one channel formed in the angled face and extending from the first axial face to the radially outer face; and
a loading ring configured to maintain contact with the angled face of the sealing ring, the first axial wall of the gland and the radial wall of the gland.

10. The apparatus of claim 9, wherein the angled face is oriented at an angle of between approximately 10° and approximately 50° relative to the radially inner face.

11. The apparatus of claim 9, wherein the at least one channel includes a plurality of circumferentially spaced channels.

12. The apparatus of claim 9, wherein the sealing ring is formed of a material comprising polytetrafluoroethylene.

13. The apparatus of claim 12, wherein the loading ring is an O-ring.

14. The apparatus of claim 13, wherein the O-ring comprises a natural or a synthetic elastomer.

15. The apparatus of claim 9, wherein the first axial face and the second axial face are substantially parallel to one another.

16. The apparatus of claim 14, wherein the radially inner face and the radially outer face are substantially parallel to, and substantially concentric with, one another.
